(19) United States
(12) Patent Application Publication
(10) Pub. No.: US 2004/0239712 A1
(43) Pub. Date: Dec. 2, 2004

(54) INKJET PRINTER USING THERMAL SENSING ELEMENTS TO IDENTIFY DIFFERENT TYPES OF CARTRIDGES

(76) Inventors: Hsieh-Sheng Liao, Yun-Lin Hsien (TW); Shih-Yen Chang, Taipei City (TW); Chung-Hsing Li, Tai-Chung City (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,029

(22) Filed: Sep. 3, 2003

(30) Foreign Application Priority Data
Sep. 5, 2002 (TW) 091120380

(51) Int. Cl. B41J 29/393

(52) U.S. Cl. 347/19

(57) ABSTRACT

An inkjet printer includes different types of cartridges and different thermal sensing elements are set on different types of cartridges. The inkjet printer utilizes a detecting circuit to generate a sensing signal according to a working temperature of a printhead sensed by the thermal sensing element. Therefore, according to the sensing signal, the inkjet printer can determine the working temperature of the printhead. Furthermore, a control circuit of the inkjet printer can also identify different types of cartridges, as values of the sensing signal generated by different thermal sensing elements fall into different ranges.

### BACKGROUND OF INVENTION

1. Field of the Invention

The invention relates to an inkjet printer, and more particularly, to an inkjet printer that identifies different types of cartridges using thermal sensing elements.

2. Description of the Prior Art

Accompanying the increasing development of the computer industry in recent years, the demand for computer peripherals is growing greater and greater. Accordingly, this phenomenon also leads to diversity in function and improvement in quality of computer peripherals. Among the variety of computer peripherals currently available, inkjet printers have always been a mainstream output device. Ever since color printing became popular, in order to improve printout quality, inkjet output devices (besides of inkjet printers, these also include fax machines and multi-function peripherals, etc.) with at least two ink cartridges have become standard. This type of cartridge supports both black/white printing and a variety of color systems.

Because a plurality of cartridges must at the same time be installed in the same inkjet printer and different cartridges are designed to support different types of color systems, a main consideration of inkjet printer makers when designing a printer is (before actual printing instructions are given) to make sure whether a cartridge has been installed into the printer to its proper position, and whether the inkjet printer can identify the type of the cartridge in order to match it to software having the same color system. According to the prior art, for the purpose of proper installment and cartridge type identification, cartridges of different appearances and structural designs accompanied with corresponding cartridge carriers on the printer side are usually used. Also, identification resistors with different resistances are installed on different cartridges respectively, and at the same time proper circuit designs are utilized. With this, the goal of cartridge identification is achieved.

But the above-mentioned techniques according to the prior art both contain factors of increased cost. For the identification technique using different appearances and structural designs in cartridges, since manufacturers have to maintain multiple assembly lines with respect to cartridges of different appearances and structural designs, cost reduction is difficult to implement.

As for the identification technique using identification resistors, use of dedicated identification resistors is inefficient. For the purpose of better printing quality as well as longer cartridge lifecycle, some current designs of inkjet printers include a thermistor or a thermal sensing element (for example, a thermal diode, a thermocouple, or a resistance temperature detector) on the printhead to generate a sensing signal according to the working temperature of the printhead. A controller of the inkjet printer can adjust parameters such as heating time of the ink according to the sensing signal to prevent overheating or underheating, and as a result better printing quality can be obtained. Therefore, the redundant use of the identification resistor and the thermistor causes unnecessary waste in cost.

### SUMMARY OF INVENTION

It is therefore a primary objective of the claimed invention to provide an inkjet printer, which identifies different types of ink cartridges using different thermal sensing elements, to solve the above-mentioned problem.

According to the claimed invention, an inkjet printer has at least one cartridge, a detecting circuit, and a controller. The cartridge has an ink reservoir, a printhead, and a thermal sensing element. The ink reservoir is used for storing ink, while the printhead is installed on a bottom side of the ink reservoir and contains a plurality of nozzles and a plurality of heating elements corresponding to the nozzles. The thermal sensing element is used for sensing a temperature of the printhead. The detecting circuit is electrically connected to the thermal sensing element and generates a sensing signal according to the temperature of the printhead sensed by the thermal sensing element. The controller is electrically connected to the detecting circuit and identifies a type of the cartridge according to the sensing signal.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of an inkjet printer according to the present invention.

FIG. 2 is a perspective view of the cartridge in FIG.1.

FIG. 3 is a detailed view of the cartridge in FIG. 2.

FIG. 4 is a block diagram of a preferred embodiment of the inkjet printer according to the present invention.

FIG. 5 is a diagram showing variation in the sensing signal of FIG. 1 with respect to temperature.

FIG. 6 is a diagram showing variation in the sensing voltage of FIG. 4 with respect to temperature.

FIG. 7 is a flowchart of a method of identifying cartridges according to the present invention.

### DETAILED DESCRIPTION

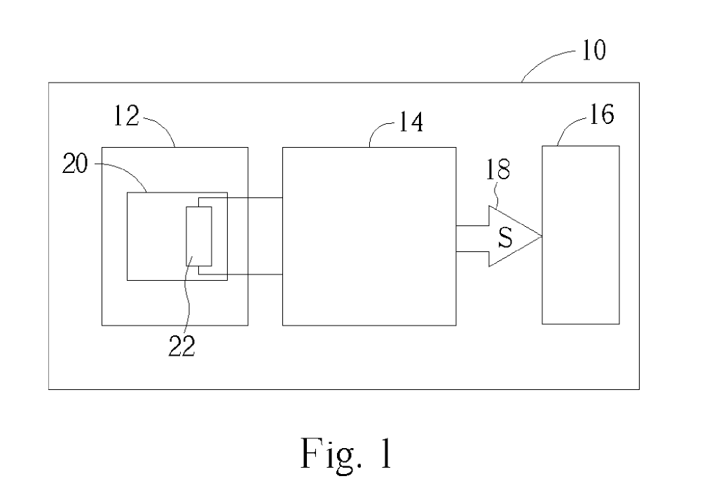

Please refer to FIG. 1. FIG. 1 shows a block diagram of an inkjet printer 10 according to the present invention. Since many features of the inkjet printer 10 are similar to those of an inkjet printer according to the prior art and are well-known to those of ordinary skill in the art, detailed descriptions are not necessary. Nevertheless, the present invention provides a method to identify types of cartridges. A thermal sensing element 22 is installed on an ink cartridge 12, such that the inkjet printer 10 can not only determine a working temperature of a printhead 20 on the cartridge 12 according to a sensing signal 18, but can also identify different types of cartridges 12 because the sensing signals 18 from different thermal sensing elements 22 will fall into different ranges. Detailed arrangements and working principles are described as follows.

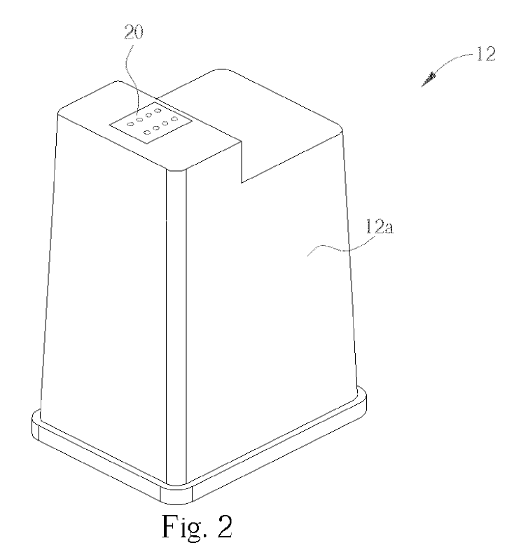

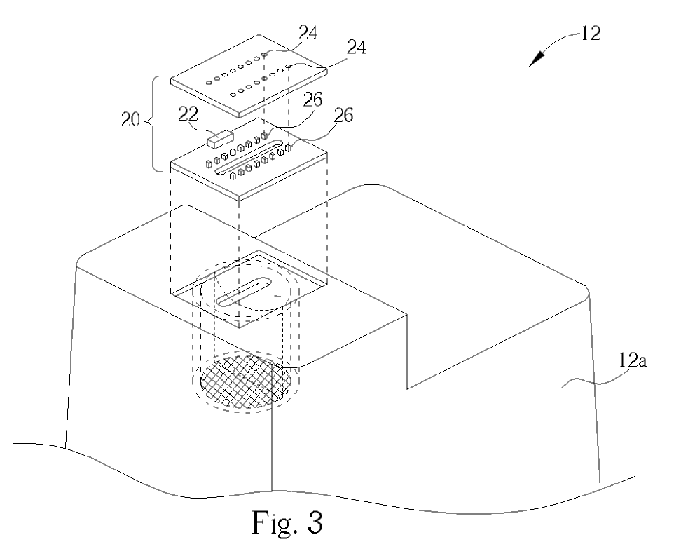

As shown in FIG. 1, the inkjet printer 10 comprises an ink cartridge 12. Detailed structures of the cartridge 12 relating to the present invention are shown in FIG. 2 and FIG. 3. As shown in FIG. 2, the cartridge 12 comprises an ink reservoir 12a for storing ink, and a printhead 20 that is installed on a bottom side of the ink reservoir 12a. As shown in FIG. 3, the printhead 20 comprises a plurality of nozzles 24, a plurality of heating elements 26 corresponding to the nozzles 24 for heating up the ink, and a thermal sensing element 22 for sensing the temperature of the printhead 20.

The inkjet printer 10 further comprises a detecting circuit 14, which is electrically connected to the thermal sensing element 22 and is used for generating the sensing signal 18 according to the temperature of the printhead 20 sensed by the thermal sensing element 22. The inkjet printer 10 also comprises a controller 16, which is electrically connected to the detecting circuit 14 and is used for identifying the type of the cartridge 12 according to the sensing signal 18.

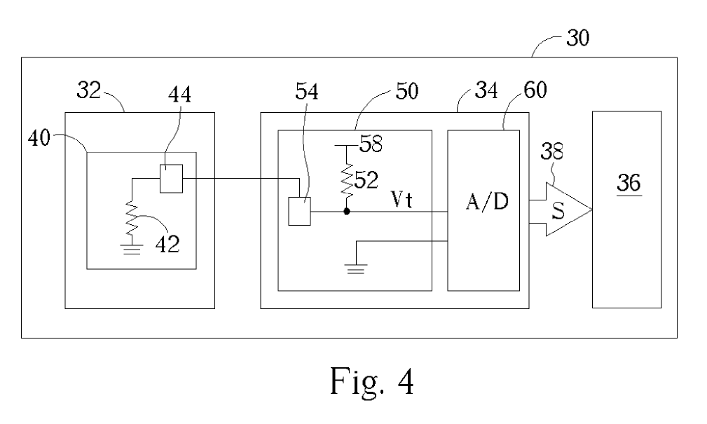

In practical applications, the inkjet printer 10 according to the present invention can also be a fax machine or a multi-function peripheral (MFP). The thermal sensing element 22 according to the present invention can be a thermistor for sensing the working temperature of the printhead 20. But devices having physical characteristics changing with temperature such as thermal diodes, thermocouples, and resistance temperature detectors (RTD) can also serve the same purpose. The detecting circuit 14 according to the present invention usually comprises a signal sensing circuit, which is electrically connected to the thermal sensing element 22 and is used for generating the sensing signal 18, and a signal converter, which is electrically connected to the signal sensing circuit and is used for converting the sensing signal 18 generated by the signal sensing circuit into other formats (for example, an analog-to-digital converter used for converting the sensing signal 18 generated by the signal sensing circuit into a digital format). Now please refer to FIG. 4. FIG. 4 shows a preferred embodiment of the inkjet printer 10 according to the present invention as shown in FIG. 1 having details as follows.

As shown in FIG. 4, an inkjet printer 30 comprises an ink cartridge 32. The structural composition of the cartridge 32 is similar to the cartridge 12 shown in FIG. 2 and FIG. 3, and a detailed description will not be repeated here. A printhead 40 is installed on the cartridge 32, and the printhead 40 comprises a thermistor 42 that is electrically connected to a detecting circuit 34 by way of a printhead contact 44 and is used for sensing the temperature of the printhead 40. The detecting circuit 34 of the inkjet printer 30 comprises a voltage divider 50 as the signal sensing circuit. The voltage divider 50 is electrically connected to the thermistor 42 by way of a detecting contact 54. The voltage divider 50 comprises a voltage source 58 and a voltage-dividing resistor 52, and is used for generating a divided voltage. If the thermistor 42 has resistance Rt, the voltage-dividing resistor 52 has resistance R, the voltage source 58 is V, and the divided voltage is Vt, then the relationship becomes: Vt=[Rt/(R+Rt)]V. The detecting circuit 34 further comprises an analog-to-digital (A/D) converter 60, which is electrically connected to the voltage divider 50 and is used for converting the divided voltage Vt into a corresponding sensing signal 38 having a digital format. The inkjet printer 30 also comprises a controller 36, which is electrically connected to the detecting circuit 34, and is used for identifying the type of the cartridge 32 according to the sensing signal 38.

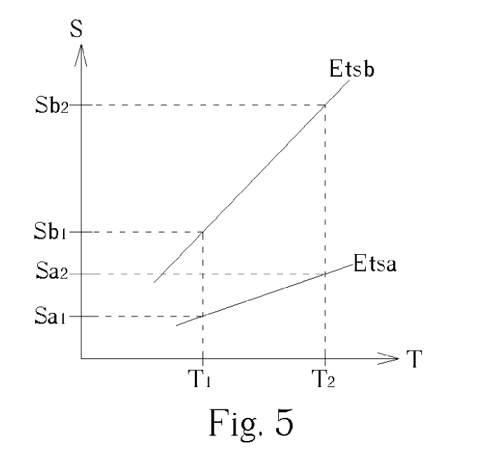

As for the working principle of the inkjet printer 10 on identifying different types of the cartridges, please refer to FIG. 1 and FIG. 4. In FIG. 1, when the thermal sensing element 22 senses the working temperature of the printhead 20, it responds with a variation in a physical parameter. The detecting circuit 14 generates a corresponding sensing signal 18 according to the physical parameter variation. In FIG. 5, the working temperature variation of the printhead 20 is represented by two temperature values T₁ and T₂ on a temperature axis T. In other words, the temperature varies between T₁ and T₂. A relationship between the temperature variation of the printhead 20 and the physical parameter variation of the thermal sensing element 22 is represented by a thermal sensing element curve Etsa. According to curve Etsa, the sensing signals corresponding to temperatures T₁ and T₂ are Sa₁ and Sa₂, respectively. As a result, the controller 16 can determine the working temperature of the printhead 20 by judging the sensing signal value between Sa₁ and Sa₂, and according to the determined working temperature give appropriate commands to the inkjet printer 10 for adjusting parameters such as ink heating time.

If another ink cartridge 12 of a different type is installed with another thermal sensing element 22 of different physical parameter variation characteristics with respect to temperature variation, then a relationship between the temperature and the corresponding sensing signal 18 generated by the detecting circuit 14 can be represented by another thermal sensing element curve Etsb. According to curve Etsb, the sensing signals corresponding to temperatures T₁ and T₂ are Sb₁ and Sb₂, respectively. Please note, in order to insure that the sensing signals 18 caused by different thermal sensing elements 22 fall into different ranges, so as to identify different types of cartridges 12, the sensing signal value Sb₁ must be greater than the sensing signal value Sa₂ in FIG. 5. In other words, a sensing signal range (between Sa₁ and Sa₂) defined by the thermal sensing element curve Etsa with respect to a temperature range between T₁ and T₂ shall not have any overlapping region with a sensing signal range (between Sb₁ and Sb₂) defined by the thermal sensing element curve Etsb with respect to the same temperature range.

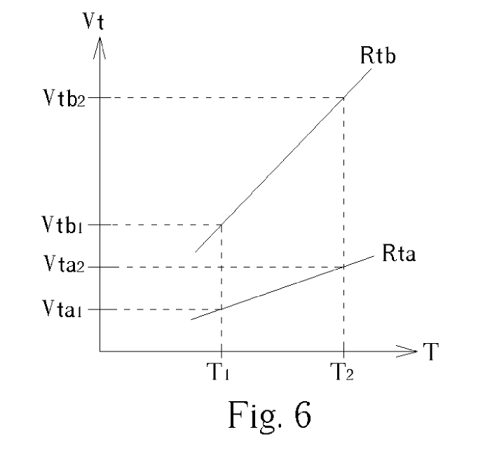

When the detecting circuit 14 generates a sensing signal 18, by judging in which sensing signal range on the sensing signal axis S the sensing signal 18 falls, the controller 16 is able to determine by which thermal sensing element 22 the sensing signal 18 is generated. That is, the controller 16 can identify the corresponding ink cartridge 12 through the above-mentioned method of identifying the thermal sensing element 22. By applying the same working principle, only dividing the sensing signal axis S into a plurality of smaller sensing signal ranges corresponding to different thermal sensing element curves, at the same time still insuring no overlap between any two ranges, then more types of the ink cartridges 12 can be identified. Now please refer to FIG. 4 and FIG. 6. In FIG. 4 and FIG. 6 a preferred embodiment of the above-mentioned working principle of identifying different types of ink cartridges 12 by an inkjet printer 30 according to the present invention is given and is described as follows.

In FIG. 4, after sensing a working temperature of the printhead 40 the thermistor 42 presents a corresponding resistance value. The voltage divider 50 in the detecting circuit 34 generates a corresponding divided voltage according to the resistance value, and the divided voltage is converted by an analog-to-digital converter 60 into a sensing signal 38 having a digital format. In FIG. 6, the working temperature variation of the printhead 40 is represented by two temperature values T₁ and T₂ on a temperature axis T. In other words, the temperature varies between T₁ and T₂. The relationship between the temperature variation of the printhead 40 and the resistance value variation of the thermistor 42 is represented by a thermistor curve Rta. According to curve Rta, the sensing signals corresponding to temperatures T₁ and T₂ are Vta₁ and Vta₂, respectively. As a result, the controller 36 can determine the working temperature of the printhead 40 by judging the sensing signal value between Vta₁ and Vta₂, and according to the determined working temperature give appropriate commands to the inkjet printer 30 for adjusting parameters such as ink heating time.

If another ink cartridge 32 of a different type is installed with another thermistor 42 having a different resistance value variation characteristics with respect to temperature variation, then the relationship between the temperature and the corresponding sensing signal 38 generated by the detecting circuit 34 can be represented by another thermistor curve Rtb. According to curve Rtb, the sensing signals corresponding to temperatures T₁ and T₂ are Vtb₁ and Vtb₂, respectively. Please note, in order to insure that the sensing signals 38 caused by different thermistor 42 fall into different ranges, so as to identify different types of cartridges 32, the sensing signal value Vtb₁ must be greater than the sensing signal value Vta₂ in FIG. 6. In other words, a sensing signal range (between Vta₁ and Vta₂) defined by the thermistor curve Vta with respect to a temperature range between T₁ and T₂ shall not have any overlapping region with a sensing signal range (between Vtb₁ and Vtb₂) defined by the thermistor curve Vtb with respect to the same temperature range.

When the detecting circuit 34 generates a sensing signal 38, by judging in which sensing signal range on the sensing signal axis S the sensing signal 38 falls, the controller 36 is able to determine by which thermistor 42 the sensing signal 38 is generated. This means, the controller 36 can identify the corresponding ink cartridge 32 through the above-mentioned method of identifying the thermistor 42.

Moreover, the thermal sensing element 22 can also be installed on the ink cartridge 12 outside the printhead 20 while still retaining the function of sensing the temperature of the printhead 20.

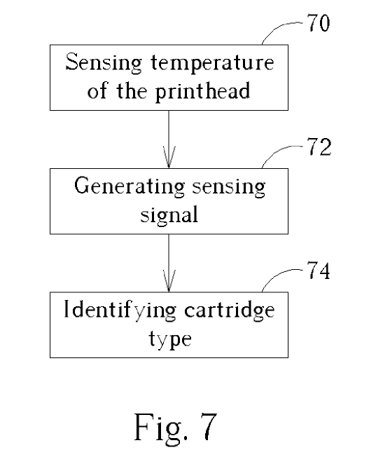

Please refer to FIG. 7. FIG. 7 shows a flowchart of a method of identifying types of ink cartridges according to the present invention. Take the inkjet printer 10 in FIG. 1 for example, wherein the parts comprised are as mentioned above. The method comprises the following steps:

Step 70: sensing a temperature of the printhead 20 on the cartridge 12 with the thermal sensing element 22;

Step 72: generating a sensing signal 18 with the detecting circuit 14 according to the temperature sensed by the thermal sensing element 22;

Step 74: identifying a type of the cartridge 12 with the controller 16 according to the sensing signal 18.

Wherein the detailed working principles of each step are the same as the working principles of identifying types of ink cartridges 12 by the inkjet printer 10 mentioned above, and therefore repeated descriptions are unnecessary.

Compared to the inkjet printer according to the prior art, which identifies types of cartridges depending on different appearances and structural designs or depending on the use of identification resistors, the inkjet printer according to the present invention utilizes existing thermal sensing elements for detecting the working temperature of the printhead to serve the purpose of cartridge type identification. This technique has the advantage of reduced cost.

Those skilled in the art will readily observe that numerous modifications and alterations of the device may be made while retaining the teachings of the invention. Accordingly, the above disclosure should be construed and limited only by the metes and bounds of the appended claims.

What is claimed is:

1. An inkjet printer comprising:
at least one cartridge comprising an ink reservoir, a printhead, and a thermal sensing element, the ink reservoir being used for storing ink, the printhead being disposed on a bottom side of the ink reservoir and comprising a plurality of nozzles and a plurality of heating elements corresponding to the nozzles, the thermal sensing element being used for sensing a temperature of the printhead;
a detecting circuit being electrically connected to the thermal sensing element and generating a sensing signal according to the temperature of the printhead sensed by the thermal sensing element; and
a controller being electrically connected to the detecting circuit and identifying a type of the cartridge according to the sensing signal.

2. The inkjet printer of claim 1 wherein the detecting circuit comprises a signal sensing circuit, the signal sensing circuit being electrically connected to the thermal sensing element and generating the sensing signal.

3. The inkjet printer of claim 2 wherein the signal sensing circuit is a voltage divider.

4. The inkjet printer of claim 2 wherein the detecting circuit further comprises a signal converter, the signal converter being electrically connected to the signal sensing circuit and converting the sensing signal generated by the signal sensing circuit into another format.

5. The inkjet printer of claim 4 wherein the signal converter is an analog-to-digital converter and converts the sensing signal generated by the signal sensing circuit into a digital format.

6. The inkjet printer of claim 1 wherein the thermal sensing element is a thermistor and a resistance value of the thermistor changes according to variation in the temperature of the printhead.

7. The inkjet printer of claim 1 wherein the thermal sensing element is a thermal diode and an output current value of the thermal diode changes according to variation in the temperature of the printhead.

8. The inkjet printer of claim 1 wherein the thermal sensing element is a thermocouple and a loop voltage of the thermocouple changes according to variation in the temperature of the printhead.

9. The inkjet printer of claim 1 wherein the thermal sensing element is a resistance temperature detector (RTD), and a voltage value or a current value of the RTD changes according to variation in the temperature of the printhead.

10. A method for identifying a type of cartridge, at least one cartridge being installed in an inkjet printer, the cartridge comprising a printhead and an ink reservoir for storing ink, the printhead being disposed on a bottom side of the ink reservoir and comprising a plurality of nozzles and a plurality of heating elements corresponding to the nozzles, the method comprising the steps of: disposing different thermal sensing elements on different cartridges;
sensing a temperature of the printhead on the cartridge with the thermal sensing element;
generating a sensing signal according to the temperature sensed by the thermal sensing element; and
identifying a type of the cartridge according to the sensing signal.

11. The method of claim 10 wherein the inkjet printer comprises a detecting circuit, the detecting circuit being electrically connected to the thermal sensing element and generating the sensing signal.

12. The method of claim 11 wherein the detecting circuit comprises a signal sensing circuit, the signal sensing circuit being electrically connected to the thermal sensing element and generating the sensing signal.

13. The method of claim 12 wherein the signal sensing circuit is a voltage divider.

14. The method of claim 12 wherein the detecting circuit further comprises a signal converter, the signal converter being electrically connected to the signal sensing circuit and converting the sensing signal generated by the signal sensing circuit into another format.

15. The method of claim 14 wherein the signal converter is an analog-to-digital converter and converts the sensing signal generated by the signal sensing circuit into a digital format.

16. The method of claim 10 wherein the thermal sensing element is a thermistor and a resistance value of the thermistor changes according to variation in the temperature of the printhead.

17. The method of claim 10 wherein the thermal sensing element is a thermal diode and an output current value of the thermal diode changes according to variation in the temperature of the printhead.

18. The method of claim 10 wherein the thermal sensing element is a thermocouple and a loop voltage of the thermocouple changes according to variation in the temperature of the printhead.

19. The method of claim 10 wherein the thermal sensing element is a resistance temperature detector (RTD), and a voltage value or a currentvalue of the RTD changes according to variation in the temperature of the printhead.
